(19) United States
(12) Patent Application Publication
(10) Pub. No.: US 2026/0149500 A1
(43) Pub. Date: May 28, 2026

(54) A TRANSCEIVER FOR FREE-SPACE OPTICAL COMMUNICATION, AND COMPONENTS THEREOF

(71) Applicant: MODE BLACK LTD, London (GB)

(72) Inventors: Matthias JÄGER, Berlin (DE); Esmond REID, Bath (GB)

(21) Appl. No.: 19/124,045

(22) PCT Filed: Oct. 20, 2023
(86) PCT No.: PCT/GB2023/052759

§ 371 Date: Apr. 24, 2025

(30) Foreign Application Priority Data
Oct. 27, 2022 (GB) 2215925.5

(51) Int. Cl. H04B 10/112; G02B 19/00

(52) U.S. Cl. CPC H04B 10/1123; G02B 19/0028; G02B 19/0076; G02B 19/0085

(57) ABSTRACT

An optical transceiver including a transmitter and a receiver fixed relative to one another. The transmitter includes a light source and a directing element, wherein the directing element is configured to direct light emitted from the light source away from the optical transceiver along a light path, and wherein the directing element is configurable to adjust the light path, and the receiver includes a lens having a focal region at a focal length and a detector arranged at the focal region of the lens, The receiver is configured with a function of merit FOM=PSA_{Aperture} (A/D): wherein PSA_{Aperture} is the projected solid angle of the receiver, A is the area of the aperture of the receiver, D is the active area of the detector, and the FOM is equal to at least 1.5.

### FIELD

The present disclosure concerns Free-Space Optical systems. More particularly, this disclosure concerns a transceiver comprising a free-space optical receiver and a transmitter. The disclosure also concerns free-space optical receivers and a method of manufacturing a free-space optical receiver.

### BACKGROUND

Free-Space Optical systems (FSO systems) are systems that transmit and/or receive light over free space, that is, where the light propagates at least some distance without being guided in a waveguide. A FSO system will typically comprise an optical transmitter and/or an optical receiver within a housing. FSO communication systems are designed to transmit a signal towards a target transceiver and also to receive signals transmitted from a target transceiver.

As used herein, the term “optical signal” refers to light generally, whether or not the light has been modulated or otherwise configured to transmit information.

The optical receiver is designed to focus light that falls within an acceptance angle onto a suitable detector. The degree to which the light can be focused is limited by several factors. A fundamental physical limitation is given by the conservation of etendue. Etendue is a measure of the spread of light, in area and angle, that an optical system can accept. Etendue can be calculated by integrating over an area A and a range of angles θ through which light arrives at a receiver, whilst taking into account the refractive index n of the medium in which the light propagates. For an infinitesimal surface element dS with a normal nₛ, where the surface is crossed by light within a solid angle dΩ at an angle θ with the normal nₛ (and hence the area of the light projected in the direction of the propagation of light is given by cos θdS), the etendue G can be defined by the following integral:

$$G = {\int }_{Ω} {\int }_{S} {n}^{2} dS cos θ d Ω \qquad Equation A$$

Over an area A and a solid angle defined by a half opening angle α of an aperture, the etendue G is given by:

$$G = π {n}^{2} A {sin}^{2} ( α ) \qquad Equation B$$

Comparing the etendue at the aperture of a receiver (G₁), and directly above an active area of a detector (G₂), one gets:

$${G}_{1} = π {n}_{1}^{2} {A}_{1} {sin}^{2} ( {α}_{1} ) = {G}_{2} = π {n}_{2}^{2} {A}_{2} {sin}^{2} ( {α}_{2} ) \qquad Equation C$$

The maximum useable entrance aperture area for the receiving optics per detector area, for the case of light travelling from air (n₁=1) to the detector, may thus be provided by:

$$\frac{{A}_{1}}{{A}_{2}} = {n}_{2}^{2} \frac{{sin}^{2} ( {α}_{2} )}{{sin}^{2} ( {α}_{1} )} \qquad Equation D$$

Mechanical instability of the components of the system, or scintillation caused by changes in the atmosphere, may impose a lower limit for the acceptance angle, below which it cannot be guaranteed both that (i) light reaches the receiver and that (ii) the light that does reach the receiver is within the acceptance angle of the receiver. However, this lower limit can be improved using active tracking and/or adaptive optics.

The concentration of light in a receiver of an FSO-system may be achieved by using imaging optics, non-imaging optics or a combination thereof. Typical FSO-Systems concentrate the light using lenses and/or a receiving telescope comprising a plurality of optical components; however, these introduce air gaps into the system, which limits the usable etendue, by imposing a maximum angle of incidence on the detector and/or as a result of there being a low refractive index material (for example vacuum or air) directly adjacent to the detector. Having multiple independent optical components separated by air gaps can also introduce losses via unwanted reflection or scattering of the light. Additionally, the physical distance between the components may result in bulky systems which may be difficult to manoeuvre.

Traditional non-imaging optical systems may allow for a higher concentration of light by providing a wider range of incident angles that can be detected by a detector. In an ideal non-imaging system, the maximum angle could be α=90°. One disadvantage of using only non-imaging optical components in an optical receiver system is that light propagating through the body of the non-imaging optical component can take a wide spread of optical path lengths, due to diffraction, reflection and/or scattering effects. The wide spread of optical path lengths can limit the bandwidth of a signal transmitted by the light.

It is desirable to increase the concentration of light in optical receivers as this may allow (i) a reduction in the size of the detector (which can result in higher bandwidths and lower costs), (ii) an increase in the aperture of the receiving system (reducing geometrical losses from the transmission signal) and (iii) an increase in the acceptance angle (thereby relaxing the need for precise passive or active alignment of the optical components).

The present disclosure seeks to provide an improved transceiver for optical communication, and improved free-space optical receivers for use with such transceivers or other optical communication systems.

### SUMMARY

According to a first aspect of the present disclosure there is provided an optical transceiver having the features set out in claim 1 below.

According to a second aspect of the present disclosure there is provided a receiver for free-space optical signals having the features set out in claim 8 below.

According to a third aspect of the present disclosure there is provided a receiver for free-space optical signals having the features set out in claim 13 below.

According to a fourth aspect of the present disclosure there is provided a receiver for free-space optical signals having the features set out in claim 14 below.

According to a fifth aspect of the present disclosure there is provided an arrangement comprising a first optical transceiver and a second optical transceiver having the features set out in claim 18 below.

According to a sixth aspect of the present disclosure there is provided a method of manufacturing an optical receiver having the features set out in claim 19 below.

Preferred, but optional, features of the present disclosure are set out below and in the dependent claims.

It will of course be appreciated that features described in relation to one aspect of the present disclosure may be incorporated into other aspects.

### DESCRIPTION OF THE DRAWINGS

Embodiments of the present disclosure will now be described by way of example only with reference to the accompanying schematic drawings of which:

FIG. 1 is a schematic cross section of an optical receiver according to a first example embodiment;

FIG. 2 shows a schematic cross section of an optical receiver according to a second example embodiment;

FIG. 3 shows a schematic cross section of an optical receiver in accordance with another example embodiment, including a Fresnel entrance surface;

FIG. 4 shows a schematic cross section of an optical receiver in accordance with another example embodiment;

FIG. 5 shows a schematic cross section of an optical receiver in accordance with another example embodiment including a detector integrated within a lens;

FIG. 6 shows a detailed cross section of the detector of the example embodiment shown in FIG. 5;

FIG. 7 shows a schematic cross section of an optical receiver in accordance with another example embodiment including a first and second detector integrated within a lens;

FIG. 8 shows a schematic cross section of an optical receiver in accordance with another example embodiment including a first and second detector and a second lens integrated within a lens;

FIG. 9 shows a schematic cross section of an optical receiver in accordance with another example embodiment including a detector and a camera integrated within a lens;

FIG. 10 shows a schematic cross section of a transceiver in accordance with an example embodiment including a receiver and a transmitter; and

FIG. 11 shows a definition of the terms in the equation for etendue, G.

### DETAILED DESCRIPTION

In its first aspect, the present disclosure provides an optical transceiver comprising a transmitter and a receiver fixed relative to one another, the transmitter comprising a light source and a directing element, wherein the directing element is configured to direct light emitted from the light source away from the optical transceiver along a light path, and wherein the directing element is configurable to adjust the light path, and the receiver comprises a lens having a focal region at a focal length and a detector arranged at the focal region of the lens. The receiver is configured with a function of merit (FOM):

$$FOM = {PSA}_{Aperture} \frac{A}{D}$$

wherein PSA_{Aperture} is the projected solid angle of the receiver, A is the area of the aperture of the receiver, D is the active area of the detector, and FOM is equal to at least 1.5.

The size of prior art optical transceiver systems can be determined in part by the size of the positioning systems required for movement of the constituent transmitter and receiver. As described in more detail below, increasing the FOM results in an increased acceptance angle of the receiver. The optical transceiver has a FOM of at least 1.5, which is much larger than the FOM of prior art transceivers. The associated increased acceptance angle of the receiver reduces the sensitivity of the transceiver to its orientation relative to a corresponding transmitter, or transceiver. The transmitter comprises a directing element which allows for adjustment of the light path and, accordingly, removes the need for the entire transmitter to be movable. As such, the transceiver of the present example does not require alignment systems for the transmitter and receiver. The receiver and transmitter are therefore fixed relative to one another, which enables to the transceiver to be significantly smaller and lighter than prior art transceiver systems having smaller acceptance angles.

The receiver is for receiving free-space optical signals.

As used herein, the “focal length” is the distance from the principal imaging plane to the focal point, referred to herein as the “focal region”. The “focal region” is the region at which the highest concentration of light is reached when a narrow beam of on-axis, collimated light is incident on the first optical component. In the case of ideal imaging optics, a distant infinitesimal point on the optical axis of the system would be focused onto another single infinitesimal point on the optical axis of the system (the focal point); however, in real-life optical systems, the focal region is an aberrated focal point because optical aberrations and diffraction cause the light to spread out into a 3-dimensional volume (characterised for example by a point spread function). Thus, the region at which the highest concentration of light is reached will generally be a 3D region.

When one also considers points of the object field that are off-axis and/or not at infinity, the skilled person will understand that there will be a set of the aberrated focal points (focal regions) which together will form an extended region, or a “focal plane”, that is in focus.

The function of merit may be at least 2, at least 2.5, at least 3, at least 3.2, at least 6, or at least 8.

The directing element may comprise a flat surface with a reflecting layer. The surface may be positioned at an angle relative to the light emitted light from the transmitter source. The directing element may be movable to change the angle at which it is oriented relative to the light emitted from the transmitter source. The directing element may comprise a mirror. The directing element may be rotatable about two axes. The directing element may comprise a micromechanical mirror. The directing element may comprise a beam divider. The transceiver may be configurable to move the light path by at least 0.5 degrees. The transceiver may be configurable to move the light path by between 0.5 degrees and 30 degrees. In some embodiments, the transceiver may be configured to move the light path by up to 360 degrees. The directing element may form part of a microelectromechanical system. The micromechanical system may be configured to move the light path by an angle of at least 0.25 degrees using electromagnetic forces. The directing element may be an optical phased array. The optical phased array may adjust the light path by applying a location dependent phase shift.

The acceptance angle of the receiver may be between 0.5 and 30 degrees. The acceptance angle may be at least 0.5 degrees, at least 1 degree or at least 5 degrees. The acceptance angle may be at least 7 degrees.

The transceiver may be configured to emit light as a collimated beam. The transceiver may be configured to emit light as a collimated beam with a beam divergence. The beam divergence may be much smaller than the acceptance angle. For example, the beam divergence may be less than 1% of the acceptance angle. The beam divergence may be between 0.001 milliradians and 10 milliradians. The beam divergence may be no more than 1 milliradians, 2 milliradians or 5 milliradians. The skilled person will of course understand that π radians is equal to 180 degrees. The beam divergence may be adjustable. Dynamically increasing beam divergence may be beneficial for allowing the transceiver to work at shorter ranges, or to help with initial alignment. Adjustability could be achieved by a moveable or deformable lens in the transmit beam.

The optical receiver may have a bandwidth of at least 3 Mbit/s. The bandwidth may be between 3 MBit/s and 10 Gbit/s. The bandwidth may be 10 MBit/s, 12.5 MBit/s, 100 MBit/s, 125 MBit/s, 1 GBit/s or 1.25 GBit/s. The lens may be a catadioptric lens. The optical transceiver may comprise a housing. The transmitter and receiver may be contained within the housing. The transmitter and receiver may be fixed within the housing. The transceiver may be mounted on a gimbal. The receiver of the transceiver may be the optical receiver of any of the aspects of the present disclosure described below.

The detector may comprise a plurality of detectors, in which case the detector may be a multi segment detector. The total active area of the detector may therefore be equal to the sum of the active areas of each of the individual detectors of the plurality. In cases where the detector is a multi segment detector, the active area of the detector, D, refers to the active area of a single segment. A plurality of detectors may be advantageous where a particular detector active area and target bandwidth is desirable but where the bandwidth of an individual detector is limited by the size of that individual detector. For example, the bandwidth of an individual photodiode decreases with increasing active area of the photodiode, as will be understood by the skilled person. As such, a photodiode having a diameter of 2 millimetres may allow for a bandwidth of between about 25 MHz and 40 MHz. A 1 mm diameter photodiode may allow for a bandwidth of 75 MHz or 150 MHz. A 0.5 mm diameter photodiode may allow for a bandwidth of 350 MHz or 700 MHz. For a given target bandwidth this limits the maximum area of the photodiode.

The sensitivity of a receiver is defined by the effective aperture. This is the part of the entrance aperture through which incident light reaches the detector. For example, the aperture may be circular. The aperture may have a diameter which is smaller than the diameter of the lens. The aperture may have a diameter between 10 and 100 millimetres. That aperture may have a diameter of between 30 and 70 millimetres. In some embodiment, the aperture may have a diameter of approximately 50 millimetres. A portion of the circle may be occluded in which case the effective aperture is smaller than the area of the circle. The sensitivity is further influenced by the sensitivity of the detector and any optical losses within the system.

For a given size of detector and a given aperture size, the acceptance angle of the system depends on the range of angles of incidence onto the detector used directly above the detector surface and the refractive index of the material directly above the detector surface.

It is possible to increase the acceptance angle of the receiver by decreasing the distance between the lens and the detector, increase of the refractive index on the beam path in front of the detector, and the use of detector arrays to increase the total detector active area.

Decreasing the distance between the lens and the detector can be achieved by Decreasing the focal length of the lens. For a traditional system the focal length may be 1.5 times the aperture diameter. In this case a range of incidence angles on the photodetector of 37 degrees can be used. If the focal length is reduced to 0.5 times the aperture diameter, a range of incidence angles on the photodetector of 90 degrees can be used. This could translate to the increase of the device FOV from 0.1 degrees to 0.22 degrees. This increase in used incidence angles onto the detector from 37 degrees to 90 degrees may correspond to an increase in the FOM by a factor of 4.9.

In an extreme case for example as part of a catadioptric system a spherical mirror may be used where the mirror is extended far enough such that its edge is in the same plane that includes its focal spot and the detector is placed at the focal spot. In this case a range of incidence angles on the photodetector of 180 degrees can be used. This could translate to the increase of the device FOV from 0.1 degrees to 0.32 degrees. This increase in used incidence angles onto the detector from 37 degrees to 180 degrees may correspond to an increase in the FOM by a factor of 9.9.

A typical FSOC system may have an air gap between the optics and the detector and thus an refractive index of n=1. An increased FOV system with the detector in close proximity may have filled any gap with a high reflective index immersion liquid or a high refractive index adhesive. The high refractive index immersion liquid or adhesive may have a refractive index of about n=1.6. This could translate to the increase of the device FOV from 0.1 degrees to 0.16 degrees. This increase in refractive index from 1 to 1.6 may correspond to an increase in the FOM by a factor of 2.6.

In cases where a layer between the optics and the detector or the detector itself has a lower refractive index than the optics, not all possible angles in the optics may be useable for transmission into the detector. In this case, the most acute angles that would correspond to a larger angle than 90° in the lower refractive index material may experience total internal reflection at the interface to that material. In these cases maximum etendue is achieved if all possible angles in the material close to the detector with the lowest refractive index are used. This may correspond to a smaller range of angles in a higher refractive index material.

If a plurality of detectors are used the electrical characteristics of each individual detector may correspond to a single detector of the size of a segment whilst the useable surface may correspond to the sum of all elements. The use of a 9-segment detector may result in an increase of the FOM by a factor of 9.

In a transceiver where the divergence angle of the transmit beam is smaller than the acceptance angle of the receiver, an increase in acceptance angle is desirable because it allows for a larger range of angles in which the transceiver can communicate by just adjusting the orientation of the transmitted light source only, rather than the orientation of the whole system. Larger changes in relative angle between transceivers may occur on a slower time scale than smaller changes. Thus a larger range of angles that can be achieved without changing the orientation of the transceiver may remove the need for a mechanical solution for changing the orientation of the transceiver, or may reduce the requirements for speed and/or accuracy of such a solution.

A second aspect of the disclosure provides an optical receiver comprising a lens having a focal region at a focal length, a mounting portion protruding away from a surface of the lens at the focal region, and a detector mounted to a distal end of the mounting portion, wherein the lens is configured to receive light from an acceptance angle and to direct said light to the detector via the mounting portion.

The mounting portion of the optical receiver according to this aspect of the disclosure provides a convenient means of aligning and fixing the detector with respect to the lens at a position which is very close to the focal region, and thereby enables the detector to receive light from the full, or close to the full acceptance angle of the lens. The acceptance angle of the receiver may be equal to, or approximately equal to the acceptance angle of the lens.

The lens may be a catadioptric lens. As the skilled person will understand, a catadioptric optical component is an optical component that both reflects and refracts light, for example a lens partially coated with a reflective coating.

The mounting portion is fixed to the lens at the focal region of the lens. As used herein, “at the focal region” means exactly coincident with the focal region of the lens or in close proximity to the focal region of the lens. An entrance plane of the mounting portion may therefore be exactly coincident with the focal region of the lens or the entrance plane of the mounting portion may be in close proximity to the focal region lens. Thus, the distance between the entrance plane of the mounting portion component and the focal region may be less than 10% of the focal length of the lens. The distance may be for example from 0.01 mm to 50 mm.

The lens may comprise a front surface, a rear surface, and a reflector on the rear surface. The reflector on the rear surface may be arranged to reflect light that passes through the front surface to the focal region of the lens. The lens may comprise a reflector on the front surface. The reflector on the rear surface may be arranged to reflect light that passes through the front surface to the reflector on the front surface, and the reflector on the front surface may be arranged to reflect the light to the focal region of the lens. The front surface may comprise a concave surface. The rear surface may comprise a flat surface. The reflector on the front surface may be flat or substantially flat. The reflector on the rear surface may be flat or substantially flat.

The mounting portion may be a protrusion. The protrusion may have a flat surface. The flat surface may act as the exit aperture of the optics. The flat surface may have a shape and size that closely matches the shape and size of the active area of the detector. For a 2 mm diameter circular detector active area the flat surface may be circular with a diameter of approximately 2 mm (for example, 1.98 mm).

The detector may be directly bonded to the flat surface of the protrusion. The detector may be bonded using an high refractive index adhesive. The high refractive index adhesive may have a refractive index in the range of 1.3 to 2.0. The detector may have a refractive index of 1.6. The lens may have a refractive index larger than the high refractive index adhesive. For example The lens may have a refractive index of 3.67.

The protrusion may be tapered such that its cross section gets smaller the closer to the detector it gets. It may be tapered such that it can transmit light within a given solid angle to the flat surface without relying on reflection. That solid angle corresponds to a larger solid angle in the lower refractive index of the high refractive index adhesive. It may correspond to a solid angle of 2 pi in the lower refractive index of the high refractive index adhesive. It may include all rays received onto the flat surface at the interface to the high refractive index adhesive that would not be subjected to total internal reflection. It may include all rays received onto the flat surface at the interface to the high refractive index adhesive that would not be reflected at the interface by more than a certain percentage. That percentage may be between 5% and 100%. It may for example be 30% or 50%. The reflection at the interface may be reduced by additional layers functioning as an anti reflection coating.

The tapering of the protrusion may be such that it depends on reflections off the side walls of the protrusion for some rays to reach the detector. It may form a non-imaging optical element. Reflections at the side walls may happen by total internal reflection, partial internal reflection or the use of a mirror coating applied to the side walls.

The protrusion may be shaped such that it allows space for viewing the bonding area during the bonding process for example with a microscope. The protrusion may be shaped such that it allows space for bonding wire(s) for the electrical connection of the detector that extend(s) beyond the detection surface in the direction of the lens.

The lens may comprise front surface and a rear surface, wherein the front surface comprises an entrance aperture and the mounting portion and the rear surface comprises a reflector. Light entering through the aperture at the front surface is reflected from the reflector at the back surface to the mounting portion at the front surface. The mounting portion at the front surface may be at or close to the centre of the front surface. The entrance aperture at the front surface may be annular.

The lens may comprise front surface and a rear surface, wherein the front surface comprises an entrance aperture and a reflector and the rear surface comprises a reflector and the mounting portion. Light entering through the aperture at the front surface is reflected from the reflector at the back surface to the reflector at the front surface from where it is reflected to the mounting portion at the rear surface. The mounting portion at the rear surface may be at or close to the centre of the rear surface. The reflector at the front surface may be at or close to the centre of the front surface. The reflector at the rear surface may be annular. The entrance aperture at the front surface may be annular.

The lens may comprise a concave front surface and a flat rear surface, a flat reflector on the front surface and a flat reflector on the rear surface, wherein the flat reflector on the rear surface is arranged to reflect light that passes through the concave front surface to the flat reflector on the front surface, and the flat reflector on the front surface is arranged to reflect the light to the focal region of the lens. The focal region may be at the rear surface of the lens. The focal region may be located in an optically transmissive region, surrounded by the flat reflector on the rear surface of the lens.

The flat reflector on the rear surface may be annular. The flat reflector on the rear surface may cover between 50 and 99% of the rear surface. The flat reflector may comprise a reflective coating on the rear surface. The flat reflector on the front surface may be circular. The lens may have a flat region at the centre of its front surface. The flat surface may provide the flat reflector. The flat reflector on the front surface may cover between 25 and 50% of the front surface. The flat reflector may comprise a reflective coating on the front surface.

The reflector(s) may comprise a metal layer deposited on a surface. The reflector(s) may comprise a dielectric mirror. The reflector(s) may comprise multiple layers of material comprising alternating refractive indices. The multiple layers of material may form a dielectric mirror.

For the optical receivers of each of the aspects of this disclosure, the front surface of the lens is the surface that is optically closest to the front of the receiver. For example, the receiver may include a window for receiving light and the front surface of the lens may be the surface facing towards the window. The window may be an aperture. The window may be a sheet material. For the optical receivers of each of the aspects of this disclosure, the lens may be formed from glass. The lens may be formed from one or more of Silicon, Calcium Fluoride, Magnesium Fluoride, Potassium Bromide, Zinc Selenide, Sodium Chloride, Zinc Sulphide. The lens may be formed from a polymer material.

The optical receiver may comprise a liquid disposed between the lens and the mounting portion. The optical receiver may comprise a liquid disposed between the mounting portion and the detector. Advantageously, the liquid may be an index matching liquid or a high refractive index liquid. Advantageously, the liquid may provide a reduction in the reflections at the interfaces of the components of the optical receiver, whilst simultaneously compensating for inaccuracies or unevenness at the interface of the surfaces. The liquid may allow for the compensation of thermal expansion of the components. The liquid may be a glue. Adhesives such as glue may be used to provide structural support.

The lens and the mounting portion may be monolithic. The mounting portion may be deposited on the lens, for example by using an additive or subtractive process such as 3D printing or lithography. The mounting portion may be formed by an additive manufacturing process and subsequently fixed to the lens. The mounting portion may comprise a body having opposing circular, or substantially circular ends. The body may be cylindrical. The body may be frustroconical. Where the body is frustroconical, the body will have a first substantially circular end and a second, opposing substantially circular end, wherein the first circular end has a diameter which is greater than the second circular end. The first circular end may be arranged at the focal region of the lens. The detector may be mounted to the second circular end.

A third aspect of the disclosure provides a free-space optical receiver comprising a catadioptric lens having a focal region at a focal length, and a detector mounted at the focal region, wherein the lens comprises a concave front surface and a flat rear surface, a flat reflector on the front surface and a flat reflector on the rear surface, wherein the flat reflector on the rear surface is arranged to reflect light that passes through the concave front surface to the flat reflector on the front surface, and the flat reflector on the front surface is arranged to reflect the light to the focal region of the lens. The focal region may be at the flat rear surface of the lens.

The detector is fixed to the lens at the focal region of the lens. A detecting surface of the detector may therefore be exactly coincident with the focal region of the lens or the detecting surface of the detector may be in close proximity to the focal region lens. Thus, the distance between the detecting surface of the detector and the focal region may be less than 10% of the focal length of the lens. The distance may be for example from 0.01 mm to 50 mm.

The optical receiver may comprise a liquid disposed between the lens and the detector. Advantageously, the liquid may be an index matching liquid. Advantageously, the liquid may be a high refractive index liquid or adhesive. Advantageously, the liquid may provide a reduction in the reflections at the interfaces of the components of the optical receiver, whilst simultaneously compensating for inaccuracies or unevenness at the interface of the surfaces. The liquid may allow for the compensation of thermal expansion of the components. The liquid may be a glue. Adhesives such as glue may be used to provide structural support.

A fourth aspect of the disclosure provides an optical receiver comprising a comprising a catadioptric lens having a focal region at a focal length and a detector arranged at the focal region, wherein the detector is embedded within the lens, between a light-receiving front surface and a reflecting rear surface of the lens, and wherein the lens is configured such that light entering the lens through the light-receiving front surface is reflected towards the focal region by the reflecting rear surface.

The front surface of the lens may be convex. The rear surface of the lens may be convex. The front surface of the lens may comprising a light receiving portion and a reflective portion. The light reflected by the reflective rear surface may be reflected to the reflective portion of the front surface. The reflecting rear surface may be concave. The reflecting rear surface may be flat. The reflecting front surface may be concave. The reflecting front surface may be flat. The light reflected to the reflective portion of the front surface may be reflected by the reflective portion of the front surface towards focal region.

The detector may be positioned at the focal region of the lens. A detecting surface of the detector may therefore be exactly coincident with the focal region of the lens or the detecting surface of the detector may be in close proximity to the focal region of the lens. Thus, the distance between the detecting surface of the detector and the focal region may be less than 10% of the focal length of the lens. The distance may be for example from 0.01 mm to 50 mm.

The detector may be a photodiode comprising an active area and a bonding wire. The active area and, alternatively or additionally, bonding wire may be contained within a shell of material which is different from a material from which the lens is formed. The shell may comprise a material which has a substantially identical refractive index to a material from which the lens is formed. In cases where the lens is formed of a high refractive index material and no suitable materials for embedding of a substantially identical refractive index are available advantageously a material of an as high as possible refractive index is chosen. Advantageously the refractive index may be larger than 1.3. Advantageously the refractive index may be larger than 1.6. The detector may be contained within a cavity formed in the lens. The detector may be fixed within the cavity by an adhesive which is matched to the refractive index of the lens and/or the refractive index of the shell. The cavity may be formed in the front surface of the lens. The cavity may be formed in the rear surface of the lens.

The cavity may contain additional components. It may contain an amplifier. Advantageously the amplifier may be close to the detector. If the cavity is formed in the front surface of the lens it may contain a front facing camera to help with alignment of the receiver with respect to a transmitter, which may form part of a transceiver. It may contain an additional detector that receives light without it going through the main lens. It may receive light that goes through a smaller lens. The receiver may use the main detector for communications at a larger range and may use the additional detector for communication at a shorter range.

A sixth aspect of the disclosure provides a first optical transceiver and a second optical transceiver, wherein one or both of the first and second transceivers is a transceiver according to the first aspect of the disclosure. The transmitter of the first optical transceiver is configured to transmit an optical signal to the second optical transceiver, and wherein the detector of the receiver of the second optical transceiver is configured to receive the optical signal from the first optical transceiver.

Alternatively or additionally, the second optical transceiver may be configured to transmit an optical signal to the first optical transceiver. The detector of the receiver of the first optical transceiver may be configured to receive the optical signal from the second optical transceiver. The first and second optical transceivers may be spaced apart by at least 500 m, 1, 2, 4, or 10 kilometres. The first and second transceivers may be moving relative to one another. The first transceiver may be located on the ground. The second transceiver may be located on the ground. The first and second transceivers may therefore be configured for ground-to-ground optical communication. The first transceiver may be located in the air. The second transceiver may be located in the air. The first and second transceivers may therefore be configured for air-to-air optical communication. In some embodiments the optical transceivers may be located in the air and the other of the optical transceivers may be located on the ground. The first and second transceivers may therefore be configured for ground-to-air or air-to-ground optical communication.

A seventh aspect of the disclosure provides a method of manufacturing an optical receiver comprising a catodioptric lens and a detector, the method comprising the steps of:
forming a cavity in a surface of the catadiotropic lens,
placing a detector in the cavity,
aligning the detector by adjusting the position of the detector within the cavity until a detecting surface of the detector is located at a focal region of the lens,
fixing the position of the detector within the cavity.
   The resulting optical receiver may be an optical receiver in accordance with the fourth aspect of this disclosure. The lens may have a focal region at a focal length. The lens may comprise a convex light-receiving front surface and a concave reflecting rear surface. The lens may be configured such that light entering the lens through the light-receiving front surface is reflected towards focal region by the reflecting rear surface. The cavity may be formed during the process of forming the lens, for example during a moulding process. The cavity may be formed by drilling a hole in the lens, using diamond turning or etching. An end of the cavity may be at or near a focal region of the lens. The cavity may be a blind hole. The depth of the cavity may be between 4 mm and 20 mm. The depth of the cavity may be between 1% and 80% of the thickness of the lens. The detector may be placed in the cavity with an active area of the detector facing a reflective surface from which light will be received by the detector.

The method may comprise placing a liquid in the cavity. The liquid may be a glue or other adhesive. The step of aligning the detector may comprise moving the detector within the liquid. Where the liquid is an adhesive, the step of fixing may comprise curing the adhesive. The adhesive may be a UV-curing adhesive, in which case the method may comprise the step of curing the adhesive using UV light. The cured adhesive may have a refractive index which is substantially equal to the refractive index of the catadioptric lens. In cases where the lens is formed of a high refractive index material and no liquids of a substantially identical refractive index are available, advantageously a liquid having a refractive index which is as high as possible is chosen. Advantageously, the refractive index of the liquid may be larger than 1.3. Advantageously the refractive index of the liquid may be larger than 1.6.

The detecting surface may comprise an active area and a bonding wire. In some cases the detector may be supplied with a casing surrounding the detecting surface. In these cases, the method may comprise the step of removing the casing.

The method may comprise the step of depositing one or more layers of material on a detecting surface of the detector to form a shell. The one or more layers may be deposited by an additive manufacturing process. The additive manufacturing process may be a 3d printing process. The additive manufacturing process may comprise the deposition of a drop of resin and the curing of the resin. Where the detector is a photodiode, the shell may be formed around an active area and/or one or more bonding wires of the photodiode. The shell may help prevent the detector being damaged during the process of manufacturing the optical receiver.

A further aspect of the present disclosure provides an optical transceiver comprising a receiver and a transmitter fixed relative to one another, the receiver having an acceptance angle of at least 0.5 degrees and comprising a lens having a focal region at a focal length and a detector arranged at the focal region of the lens, and the transmitter comprising a light source and a directing element, wherein the directing element is configured to direct light emitted from the light source away from the optical transceiver along a light path, and wherein the directing element is movable to adjust the light path. The receiver of the optical transceiver may comprise any of the features described with respect to the optical receivers of the other aspects of this disclosure.

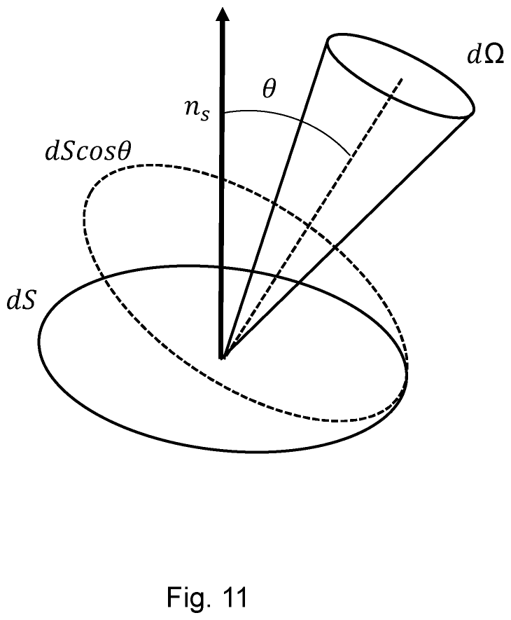

With reference to FIG. 11, etendue G can be defined as the integral over an area S and the range of possible solid angles Ω weighted with the square of the refractive index at that location n and the cosine of the angle θ measured to the orthogonal on the surface:

$$G = {\int }_{S} {\int }_{Ω} {n}^{2} cos ( θ ) d Ω dS \qquad ( 1 )$$

If the range of solid angles Ω at each point on the surface S are identical, the integrals over S and Ω become independent:

$$G = {\int }_{S} {n}^{2} dS {\int }_{Ω} cos ( θ ) d Ω \qquad ( 2 )$$

If the refractive index at all positions along the surface S are identical, then the refractive index n can be moved out of the integral:

$$G = {n}^{2} {\int }_{S} dS {\int }_{Ω} cos ( θ ) d Ω \qquad ( 3 )$$

The surface integral can be simplified to just be the surface:

$$G = {n}^{2} S {\int }_{Ω} cos ( θ ) d Ω \qquad ( 4 )$$

As such, etendue can be written as a function of refractive index n, the area S and projected solid angle (PSA), where:

$$P S A = {\int }_{Ω} cos θ d Ω$$

PSA is typically measured in projected steradians and in this unit takes a value of π if integrated over a half space above a surface.
If the solid angle takes the shape of a cone hitting the surface and is centered around the normal on the surface the projected solid angle can be simplified to:

$${\int }_{Ω} cos θ d Ω = {πsin}^{2} ϕ \qquad ( 5 )$$

where φ is the half opening angle of the cone.
If etendue is conserved, the etendue directly above the detector will be the same as the etendue at or directly in front the entrance aperture of the receiver:

$${G}_{entranceAperture} = {G}_{abovePD} \qquad ( 6 )$$

Under the simplifications described above using Equation (4) this can be written as:

$$A \cdot {n}_{Aperture}^{2} \cdot {PSA}_{Aperture} = k \cdot D \cdot {n}_{AbovePD}^{2} \cdot {PSA}_{AbovePD} \qquad ( 7 )$$

where the A is the entrance aperture area, n_{Aperture} is the refractive index at or directly in front of the entrance aperture, PSA_{Aperture} is the accepted projected solid angle at the entrance aperture, n_{AbovePD} is the refractive index at or directly in front of the detector active area, and PSA_{AbovePD} is the accepted projected solid angle used directly above the active area. The term kD is equal to the total detector active area, where D is equal to the area of the detector and k is equal to the number of detectors (i.e. k=1 if only a single detector is used).
Assuming n_{Aperture}=1, because the receiver receives light from vacuum or Air, this becomes:

$${PSA}_{Aperture} \frac{A}{D} = k \cdot {n}_{AbovePD}^{2} \cdot {PSA}_{AbovePD} \qquad ( 8 )$$

A Figure Of Merit (FOM) can therefore be define as:

$$FOM = {PSA}_{Aperture} \frac{A}{D} = k \cdot {n}_{AbovePD}^{2} \cdot {PSA}_{AbovePD} \qquad ( 9 )$$

Since the units of the area terms cancel out, the unit of the FOM is that of a projected solid angle (projected steradians).
In some cases it is possible to define the FOM in terms of angles, rather than projected solid angles, either at the aperture, the photodiode, or both. In order to define the FOM, it has to be assumed that the projected solid angle is a cone, and that the cone is centered around the normal above the surface. These assumptions cannot be made in all cases. For example, where there is a reflector on the front surface of a lens, part of the centre of the cone will be obscured by the secondary mirror. Similarly, part of the centre of the cone will be obscured if a detector is embedded in the front face of the lens.
For the entrance aperture these assumptions can be (at least in approximation) be fulfilled. But only if the Aperture area is defined not as the possibly curved surface of a lens, but instead as a planar window the light passes through.
Where it can be assumed that the projected solid angle is a cone, and that the cone is centered around the normal above the surface. It is possible to define the FOM in terms of angles by entering (5) into (9):

$$FOM = {πsin}^{2} {ϕ}_{Aperture} \cdot \frac{A}{D} = k \cdot {n}_{AbovePD}^{2} \cdot {PSA}_{AbovePD} \qquad ( 10 )$$

where φ_{Aperture} is the half angle of the acceptance cone at the entrance aperture.
Approximating the accepted projected solid angle used directly above the active area PSA_{AbovePD} with a cone (10) can be expressed as:

$$FOM = {πsin}^{2} {ϕ}_{Aperture} \cdot \frac{A}{D} = k \cdot {n}_{AbovePD}^{2} \cdot {πsin}^{2} {ϕ}_{AbovePD} \qquad ( 11 )$$

where φ_{AbovePD} is the accepted projected solid angle directly above the active area of the detector.
The receivers of the present disclosure comprise large field of view (FOV) receive optics. In other words, the receivers of the present invention are configured with larger values of FOM than the receivers of the prior art. Field of view is also referred to herein as acceptance angle; as such, the two terms are used interchangeably.
Under conservation of etendue, some of the ways in which a large receive field of view can be achieved may also sacrifice beneficial properties of the optical system. For example, the field of view can be increased by increasing the size of the detector D. For typical detectors such as InGaAs PIN or APD photodiodes this would lead to an above linear increase in cost, which is undesirable. Additionally it would non-beneficially lead to an decrease in bandwidth of the receivable signal due to the increased capacitance of the photodiode. Alternatively, the field of view could be increased by decreasing the area A of the receiver aperture. This would reduce the amount of light collected by the detector, thereby reducing the device sensitivity and hence range, which is undesirable. The receivers of the present disclosure achieve their large field of view (FOV) without these non-beneficial characteristics.

From inspection of the right hand side of the formula (8) three ways of improving the FOM are:
1. increasing the range of incidence angles onto the detector used i.e. increasing PSA_{AbovePD};
2. increasing the refractive index directly above the detector i.e. increasing n_{AbovePD}; and
3. forming the total detector area by using multiple detectors (k>1) to avoid the above-mentioned problems associated with increasing detector size.

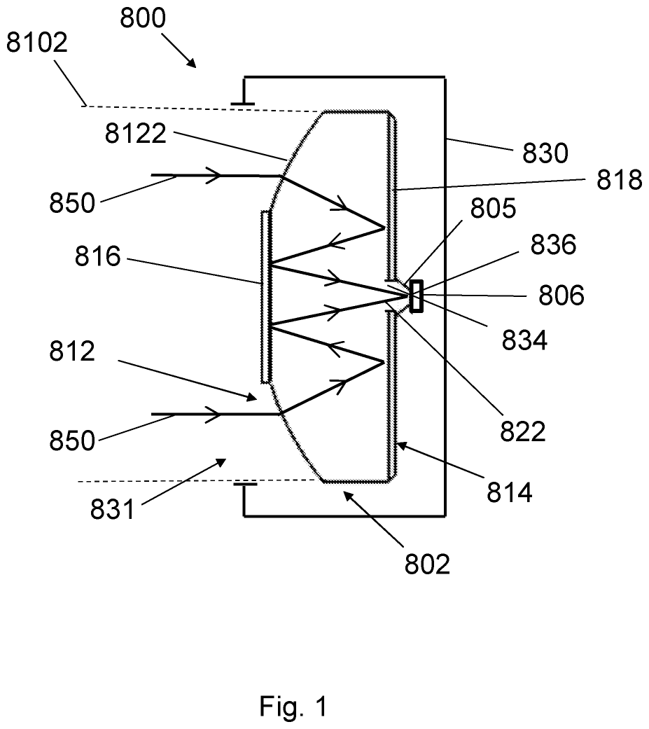

Other example embodiments will now be described in further detail with reference to FIGS. 1 to 10.

FIG. 1 shows an optical receiver 800 including a housing 830 defining an aperture that acts as a window 831 for receiving light into the receiver housing 830. The receiver 800 also includes a lens 802 comprising a curved front surface facing towards the window 831, in the form of an entrance surface 812 and a flat rear exit surface 814. In this present embodiment, the material of the lens 802 is Silicon. The refractive index (n) of the material of the present example embodiment is 3.4. However, in other embodiments the refractive index may be between 1.6 and 4.5 An optically transmissive mounting portion 805 is mounted to the exit surface 814 of the lens 802. The mounting portion 805 has an entrance plane 834 located near the exit surface 814 of the lens 802, and an exit plane 836 located opposite the entrance plane 834. A detector 806 is located at the exit plane 836. The detector 806 may be a photodiode or any other suitable detector. The close proximity of the lens 802 and the detector 806 reduces the size of the optical receiver whilst maintaining its efficiency for receiving and focusing incoming light. Additionally, the close proximity of the lens 802 and detector 806 improves mechanical stability of the optical receiver 800.

The lens 802 has a flat reflecting portion 818 at the exit surface 814 and a flat reflective portion 816 at the entrance surface 812. The reflective portion 818 of the exit surface 814 is annularly shaped such that it surrounds a central transmissive portion 822 of the exit surface 814 that is transparent to the incident light. The transmissive portion 822 of the exit surface 814 is located at a focal region of the lens 802. The reflective portion 818 of the exit surface 814 covers approximately 90% of the exit surface. (In other embodiments, the reflecting portion may cover for example from 25% to 99.9%, for example 50% to 98%, for example 85% to 95% of the exit surface.)

The reflecting portion 816 at the entrance surface 812 is located at the optical axis of the lens 802, at the centre of the entrance surface 812. In this example, the reflecting portion 816 of the entrance surface 812 is circular and covers approximately 20% of the surface of the entrance surface 812. (In other embodiments, the reflective portion 816 of the entrance surface 812 may for example cover from 0% to 50% of the surface area of the entrance surface 812.)

The mounting portion component 805 has a central body which connects the entrance plane 834 and exit plane 836. The entrance plane 834 and exit plane 836 have complimentary shapes in the present embodiment: each of the entrance plane 834 and exit plane 836 have a circular cross section. In this example, the mounting portion 805 is frustroconical in shape or, in other words, tapered with the diameter of the entrance plane 834 being greater than the diameter of the exit plane 836. In other embodiments of the invention, the mounting portion may of course have a different shape. The mounting portion 805 is a single solid component with a refractive index matched to the refractive index of the lens 802. In the presently described embodiment the mounting portion 805 and lens 802 are be monolithic. However, in other embodiments, the mounting portion may be bonded to the exit surface of the lens by a refractive index matching adhesive. In other embodiments, the mounting portion and the lens may be fixedly connected in some other way.

The detector 806 is mounted to the exit plane 836 of the mounting portion 805. The distance between the entrance plane 834 and exit plane 836 of the mounting portion 805 is approximately 2.2 mm. In other embodiments of the invention, the distance between the entrance plane 834 and exit plane 836 may generally be between 0.1 mm to 50 mm.

The propagation direction of the light through the optical receiver 800 will now be described with reference to the ray tracing 850 shown schematically in FIG. 1, which shows the beam path of collimated light falling within the acceptance angle 8102 of the receiver. The collimated light 850 enters the lens 802 at a transmissive portion 8122 of the entrance surface 812 and is refracted upon entry into the lens 802 due in part to the high refractive index of the lens 802. The light 850 propagates through the lens 802 to the exit surface 814. The light 850 is reflected by the reflective portion 818 of the exit surface 814 to the reflective portion 816 of the entrance surface 812 of the lens 802. The light 850 is further reflected by the reflective portion 816 of the entrance surface 812 to the transmissive portion 822 of the exit surface 814. The combination of the refractive index of the material of the lens 802, curvature of the entrance surface 812, and the thickness of the lens 802, ensures that the collimated light is directed to the focal region of the lens 802 and to the exit plane 836 of the mounting portion 805. The detector 806 is positioned at the exit plane 836 of the mounting portion 805 and is at or in close proximity to the focal region of the lens 802.

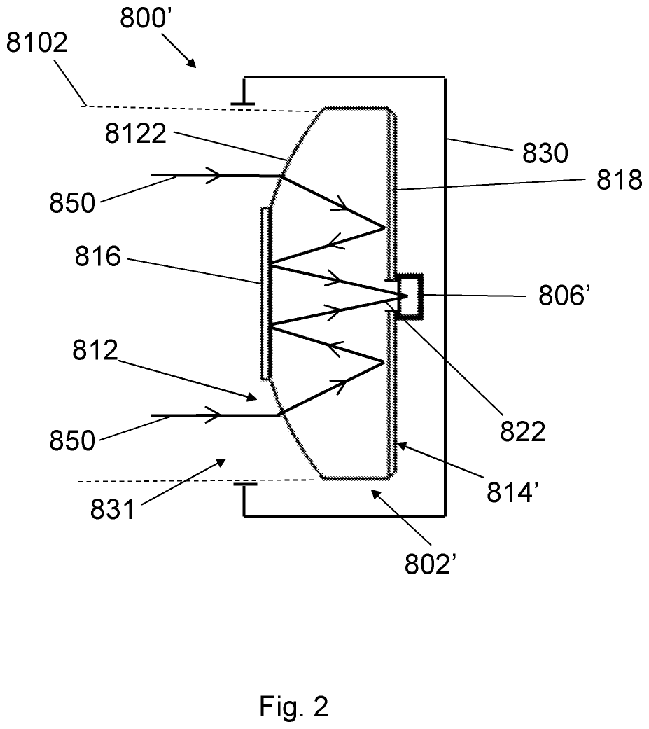

FIG. 2 shows another example embodiment of an optical receiver 800′, which has many of the features of the optical receiver 800 described with reference to FIG. 1. The same reference numerals are used to refer to and label the features which the presently described optical receiver 800′ has in common with the optical receiver 800 of FIG. 1. The optical receiver 800′ shown in FIG. 2 does not have a mounting portion. Instead, the detector 806′ is mounted directly on the exit surface 814′ of the lens 802′, and is aligned with the focal region of the lens 802′. Advantageously, mounting the detector directly to the exit surface of the lens provides a receiver with a large FOM relative to prior art systems.

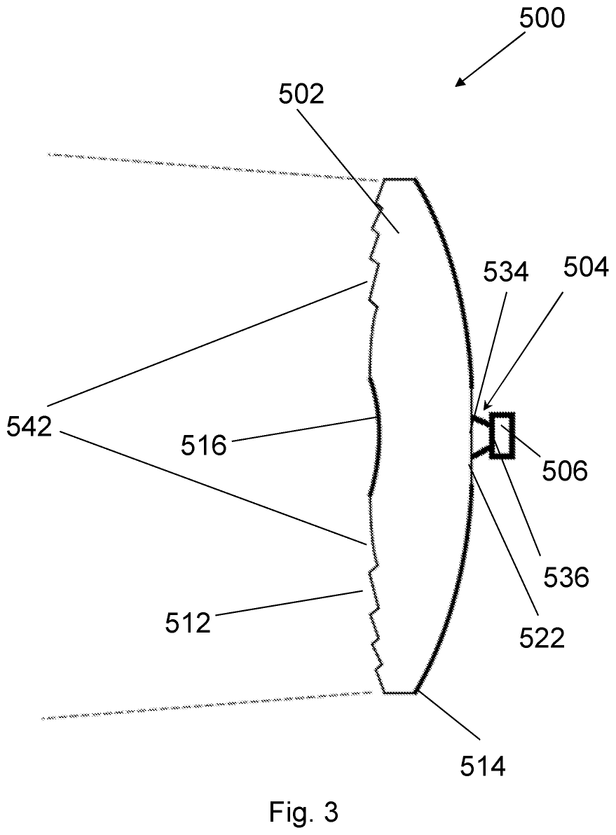

FIG. 3 shows a schematic cross section of an optical receiver 500 in accordance with another embodiment. The lens 502 of this embodiment includes a Fresnel lens. The lens 502 has a front entrance surface 512 that is a Fresnel surface and a rear exit surface 514 that is a convex lens surface. The Fresnel lens 502 has a transmissive portion 542 at the entrance surface 512 and a transmissive portion 522 at the otherwise reflective exit surface 514. The Fresnel lens 502 has a convex reflective portion 516 at the entrance surface 512 which is located at the optical axis of the Fresnel lens 502, at the centre of the entrance surface 512. In this example, the reflective portion 516 of the entrance surface 512 covers 7% of the entrance surface 512. (In other embodiments, the reflective portion 516 may cover from 0% to 50% of the surface area of the entrance surface 512.) The reflective portion 516 is curved.

The mounting portion 504 has an entrance plane 534 located near the exit surface 514 of the Fresnel lens 2, and an exit plane 536 opposite the entrance plane 534 where a detector 506 may be positioned.

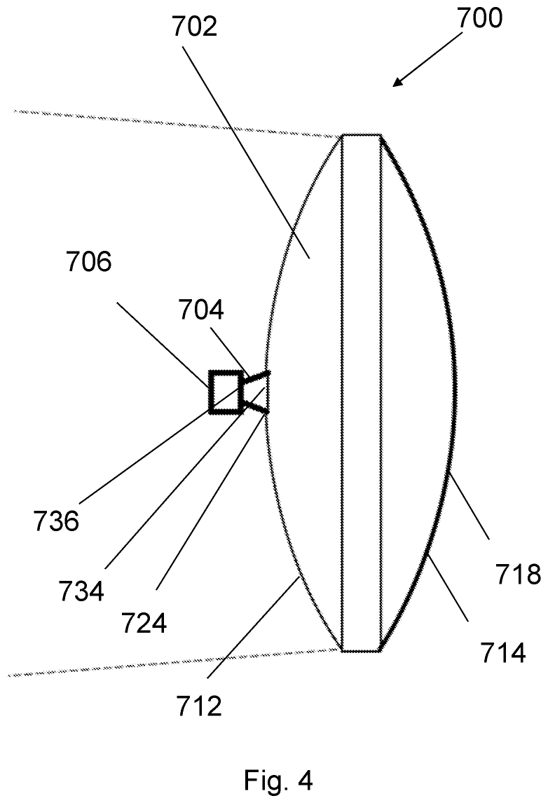

FIG. 4 shows a schematic cross section of an optical receiver 700 in accordance with another embodiment. In this embodiment, the mounting portion 704 is located on the same side of the lens 702 as the entrance surface 712 of the lens, i.e. the front side of the lens 702. The lens 702 has an entrance surface 712 which is transmissive to incident light, and a rear surface 714 which has a reflective portion 718 covering the whole of its surface. The front and rear surfaces 712, 714 are convex, and so the reflective portion 718 is concave. When light is incident on the lens 702, the light is reflected by the reflective portion 718 and directed to a central part 724 of the front surface 712, where the focal region of the lens is located. At the central part 724 of the front surface 712, the light arrives at the entrance plane 734 of the mounting portion 704. The mounting portion 704 has an exit plane 736 opposite the entrance plane 734 where a detector 706 is positioned.

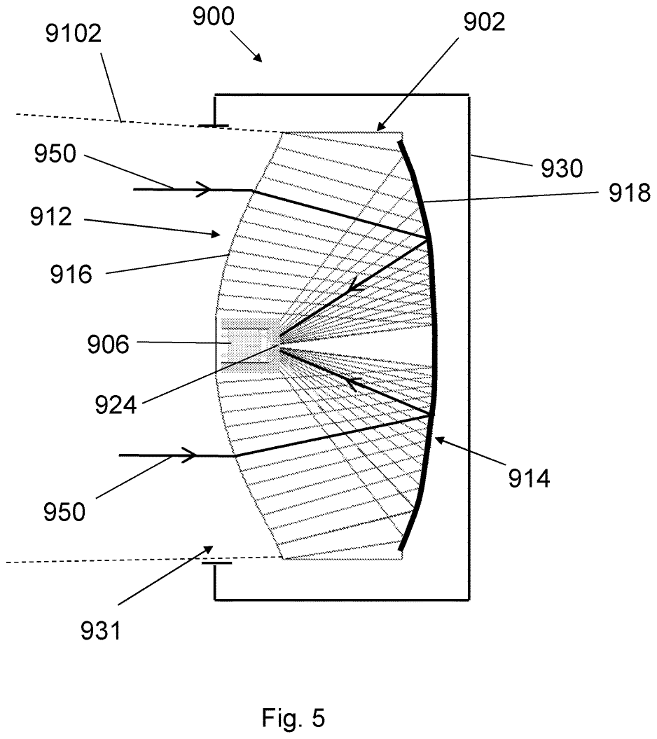

FIG. 5 shows another example embodiment of an optical receiver 900 including a housing 930 defining an aperture that acts as a window 931 for receiving light into the receiver housing 930. The receiver 900 also includes a lens 902 comprising a curved entrance surface 916 facing towards the window 931, and a curved rear surface 914. In this present embodiment, the material of the lens 902 is Zinc Selenide. The refractive index (n) of the lens in this embodiment is 2.4. In other embodiments, the lens material, and therefore the refractive index, may be different. Generally, the refractive index will be between 1.3 and 4.5.

The curved entrance surface 916 of the lens 902 is transmissible to the incident light. The ray tracing 950 shows the light incident on the transmissive entrance surface 916 and refracting upon entry into the lens 902. The curved rear surface 914 has a reflective portion 918 which covers substantially all of the rear surface 914. In other embodiments, the reflective portion 918 may cover for example from 50% to 100%, of the rear surface 914.

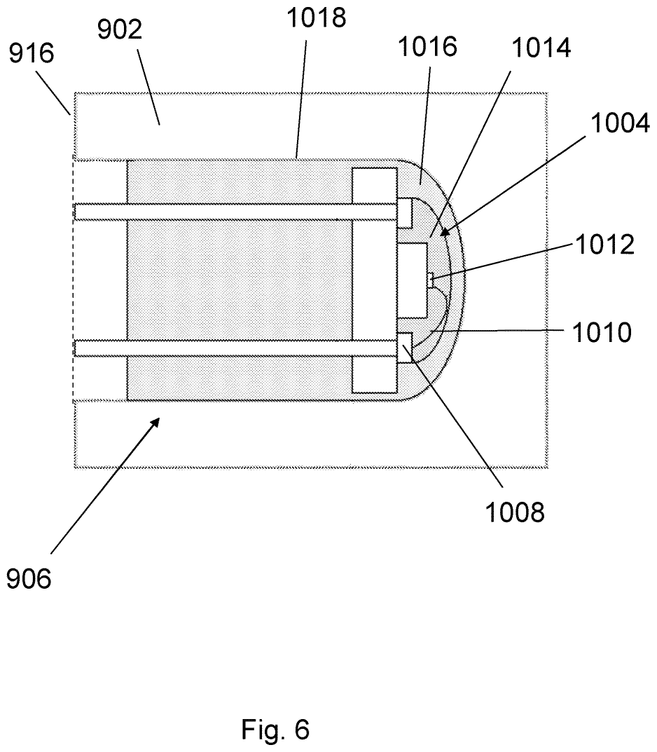

A detector 906 is housed within a cavity 1018 formed in the front surface 916 of the lens 902. The detector 906, which is shown in more detail in FIG. 6, is a photodiode 1004 comprising an active region having an active area 1012 for detecting incident light, and a bonding wire 1010 which connects the active area 1012 with a detecting pin 1008. The active region 1004 is protected by a shell 1014 which is formed by depositing one or more layers of material on the active region 1004 using an additive manufacturing process. In other embodiments, the shell 1014 may be formed using a different manufacturing process. The cavity 1018 is filled with an adhesive 1016 which is cured to fix the detector 906 at the focal region 924 of the lens 902, which in this case is situated within the lens 902, between the curved entrance surface 916 and the curved rear surface 914. The material of the shell 1014 and the adhesive 1016 have materially the same refractive index as the lens 902. In this embodiment the shell has a refractive index of 1.7, the adhesive has a refractive index of 1.6 and the lens has a refractive index of 2.4. As the match of refractive index is not perfect an additional thin layer of a refractive index between 1.6 and 2.4 is deposited on the curved surface inside the cavity. As described below, the detector 906 is configured to detect light reflected directly from the curved rear surface. Therefore the active area 1012 of the detector faces towards the curved rear surface 914 of the lens 902.

The propagation direction of the light through the lens 902 will now be described with reference to the ray tracing shown schematically in FIG. 5, which shows the beam path of collimated light falling within the acceptance angle 9102 of the receiver 900. The collimated light 950 enters the lens 902 at the transmissive entrance surface 916 and propagates through the lens 902 to the rear surface 914. The light 950 is reflected by the concave reflective portion 918 of the rear surface 914 to the focal region 924 of the lens 902, where it is received by the detector 906.

An example method of manufacturing the optical receiver 900 shown in FIG. 5 will now be described. The method involves drilling a hole in the entrance surface 916 of the lens 902 to form a cavity 1018. The cavity is formed at or near the focal region 924 of the lens 902 which is at or proximate the optical axis of the lens 902. In embodiments of the invention the depth of the cavity will generally be between 2 mm and 20 mm. An adhesive 1016 is then placed in the cavity 1018 and the detector 906 is placed in the adhesive-filled cavity 1018 with its active area 1012 facing the reflective surface 918 from which light will be received by the detector. In the case of the receiver 900 shown in FIG. 5, the active area 1012 will be configured to face the concave reflective portion 918 of the rear surface 914 of the lens 902. The detector 906 is then aligned within the cavity 1018 by adjusting the position of the detector 906 within the cavity 1018 until the active area 1021 of the detector 906 is located at or sufficiently near to the focal region of the lens 902. A reference source of optical light (not shown) may be positioned at a distance away from the lens 902 to aid with the alignment process. A transmitter, which may be part of a transceiver, may be positioned at a distance away from the lens 902 to aid with the alignment process.

When the detector 906 is suitably aligned in the cavity 1018, the adhesive 1016 is cured in order to fix the positon of the detector 906 within the cavity 1018. In this case, a UV-curing adhesive is used, so the step of curing involves the use of a UV light source. However, in other embodiments other adhesives or methods of fixing the detector may be used.

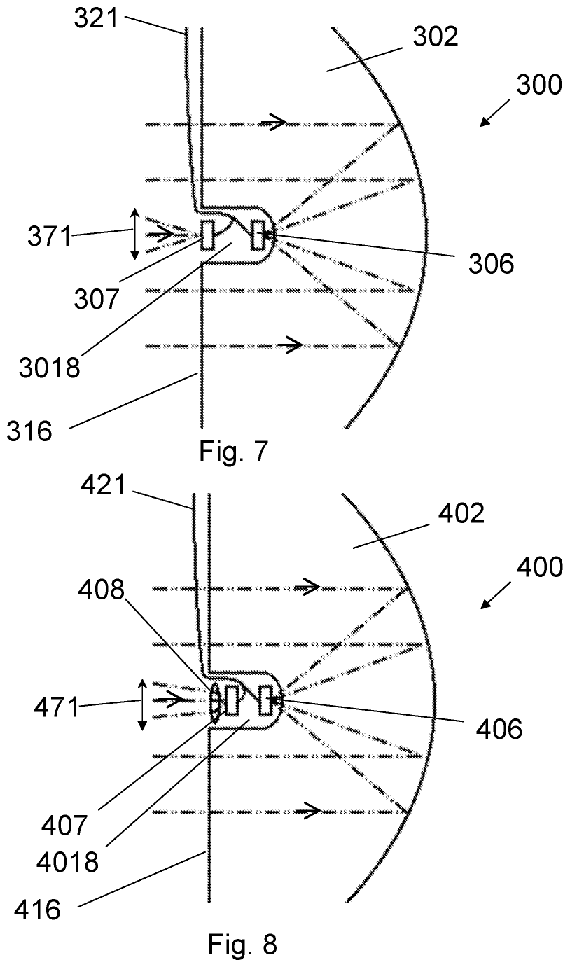

FIGS. 7, 8 and 9 show other example embodiments of optical receivers, 300, 400, 600 having detectors which are embedded within their respective lenses in a similar way to the detector 906 of the optical receiver 900 described with reference to FIGS. 5 and 6. Many parts of the receivers shown in FIGS. 7, 8, and 9, for example the housing and the features of the detector are the same, or substantially the same, as described above with reference to FIGS. 5 and 6, so are not described herein but have been labelled with like reference numerals.

The detector 300 shown in FIG. 7 comprises a lens 302 and a first detector 306 housed within a cavity 3018 formed in a front surface 316 of the lens 302. The first detector 306, which is similarly arranged to the detector 906 described above with reference to FIG. 6, is a photodiode comprising an active detecting area (not shown) configured to face the rear surface of the lens 302. The cavity 3018 also houses a second detector 307, arranged in front of the first detector 306, comprising an active detecting area (not shown) configured to face the front surface 316 of the lens 302. The second detector may be a photodiode. The second detector can be used to detect light 350 which is directed to a cavity area 371 on the front surface 316 of the lens 302, which may not have otherwise been detected by the first detector 306. The first detector 306 and the second detector 307 are connected to a cable 321 which extends away from the cavity area 371. The cable may connected to the internal electronic circuitry of, for example, a transceiver such as that described in more detail below. The depth of the cavity may be between 2 mm and 20 mm. The cavity 3018 is at or proximate the optical axis of the lens 302. An adhesive is placed in the cavity 3018 with the first and second detector 306, 307, in order to fix the detectors. The adhesive will have a refractive index which materially matches the refractive index of the material of the lens 302.

FIG. 8 shows another example embodiment of an optical receiver 400 comprising a lens 402 having a detector 406 embedded within the lens 402. The lens 402 has a first detector 406 housed within a cavity 4018 formed in a front surface 416 of the lens 402. The first detector 406, which is similarly arranged to the detector 906 described above with reference to FIG. 6, is a photodiode comprising an active detecting area (not shown) configured to face the rear surface of the lens 402. The cavity 4018 also houses a second detector 407 and a concentrator lens 408, wherein the concentrator lens 408 is at or near the front surface 416 of the lens 402. The depth of the cavity may be between 2 mm and 20 mm. The cavity 4018 is at or proximate the optical axis of the lens 402. The second detector 407 has an active detecting area (not shown) configured to face the concentrator lens 408. The concentrator lens 408 is configured to have a short focal length relative to the depth of the cavity 4018, wherein the second detector 407 is positioned at the focal region of the concentrator lens 408. The concentrator lens 408 and second detector 407 can be used to focus and detect light 450 which is incident on a cavity area 471 at the front surface 416 of the lens 402, which may not have otherwise been detected by the first detector 406.

The first detector 406 and the second detector 407 are connected to a cable 421 which extends away from the cavity area 471. The cable may connected to the internal electronic circuitry of, for example, a transceiver such as that described in more detail below. The cavity 4018 is filled with an adhesive in order to fix the detectors 406, 407 and the second concentrator lens 408. The adhesive will have a refractive index which matches the refractive index of the material of the lens 402.

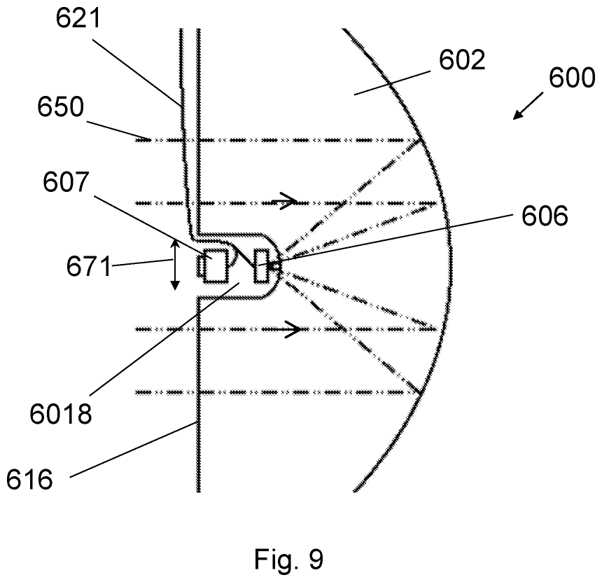

FIG. 9 shows another example embodiment of detector 600 comprising a lens 602 having a detector 606 which is embedded within the lens 602. The lens 602 has a first detector 606 housed within a cavity 6018 formed in a front surface 616 of the lens 602. The first detector 606, which is similarly arranged to the detector 906 described above with reference to FIG. 6, is a photodiode comprising an active detecting area (not shown) configured to face the rear surface of the lens 602. The cavity 6018 also houses a camera 607 located at or near the front surface 616 of the lens 602. The cavity 6018 is at or proximate the optical axis of the lens 602. The camera 607 may be fixed in the housing and configured to face the front surface 616 of the lens 602. Advantageously, the camera may be used to align an active region of the first detector 606 within the cavity 6018. Where the lens forms part of a transceiver, the camera 607 may be used to align the transceiver with a corresponding counterpart transceiver. The camera may be used to detect light incident on a cavity area 671 which may not have otherwise been detected by the first detector 606.

The first detector 606 and the camera 607 are connected to a cable 621 which extends away from the cavity area 671. The cable may connected to the internal electronic circuitry of, for example, a transceiver such as that described in more detail below. The cavity 6018 is filled with an adhesive in order to fix the detector 606 and camera 607. The adhesive used will have a refractive index which matches the refractive index of the material of the lens 602.

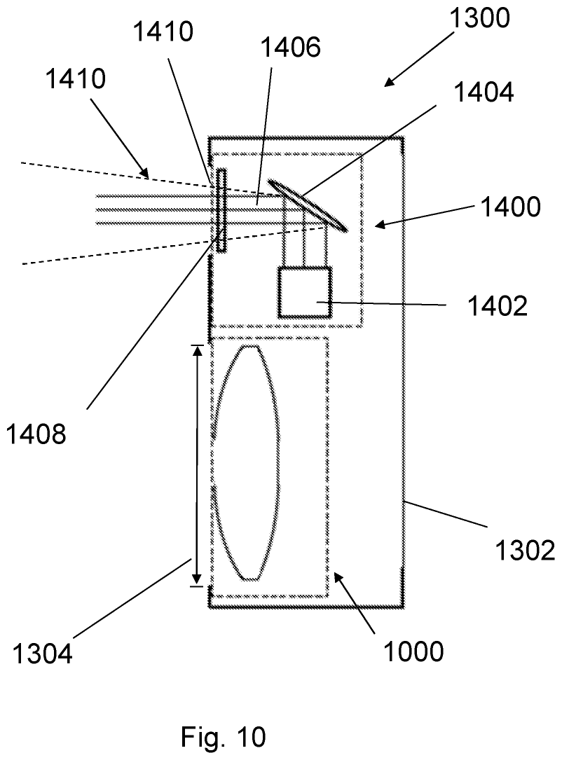

FIG. 10 shows a cross section of an optical system 1300 in accordance with another example embodiment. The optical system 1300 is an optical transceiver comprising an optical receiver 1000 and an optical transmitter 1400 fixed with respect to one another within a housing 1302. The housing 1302 protects the components from external influences such as radiation or other environmental effects. The housing 1302 has two windows; a transmitting opening 1410 and a receiving opening 1304. In other embodiments the optical transmitter 1400 and optical receiver 1000 may be housed in separate housings.

The optical receiver 1000 has an acceptance angle of 7 degrees. In other embodiments the acceptance angle may be between 0.5 and 30 degrees. In some embodiments, the optical receiver 1000 may be any of the optical receivers described above with reference to FIGS. 1 to 9.

The optical transmitter 1400 has a light source 1402, in this example a laser, a directing element in the form of a moveable mirror 1404, and a window 1408. The window 1408 may be any material that is transparent to the wavelength of the incident light. In other examples, the window 1408 may be a filter. The light 1406 from the light source 1402 is reflected by the moveable mirror 1404 through the window 1408 and exits the transmitting opening 1410. The mirror 1404 is movable to direct reflected light 1406 across a beam angle 1410 of 20 degrees. In some embodiments, the maximum beam angle 1410 may be limited by the size of the transmitting opening 1410. The moveable mirror 1404 may be moved to change the direction of the beam, by motors for example. The moveable mirror 1404 may be used to adjust for known misalignments and/or used to periodically introduce small misalignments to determine the direction into which a misalignment needs to be corrected. The moveable mirror 1404 can for example be rotated along two axis. The mirror 1404 can be moved by a motor (not shown), as part of a Micro-Electro-Mechanical Systems (MEMS) or by an actuator (not shown).

An example method for establishing a two-way link between two such transceivers is as follows:
(1) Align each transceiver to a target position. This may be manual or automated alignment, and may be to a previously known or agreed upon position or a position provided by an external system, for example a UAV or a camera with an image identification system.
(2) Scan the transmit beam of the transceivers in a field of view around those initial positions, each transceiver sending a series of identifier codes as it moves.
(3) Each transceiver monitors for the identifier codes transmitted by the other transceiver and, when one is received, adds the transmission time or a code for the pointing of the beam of the first transceiver at that time of that identifier code to its own transmissions.
(4) When a transceiver receives an identifier code from the second transceiver that includes the time delay information, use the time delay information to orient the transceiver to the orientation it was in when it sent the identifier code that was received by the other transceiver.
(5) If no link is established after a timeout period, the process may restart from step (2) with the position at which the current orientation points as the initial position.

An example method of maintaining the alignment between two transceivers is to misalign (for example periodically, or on a user instruction) one of the transceivers in all directions, for example by a circular movement of the transmit direction. The already existing data channel may then be used by the other transceiver to communicate at which misalignment position the signal was strongest and the transceiver may then be moved to that position for further transmissions. One or both transceivers may also or alternatively measure its own movements (for example measured using accelerometers on-board the transceiver) and either compensate itself for those movements by changing its position or by sending information about its movements so that the other transceiver can change its position to compensate for them.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

In some examples, an optical system may comprise more than one optical receiver.

In some examples, the detector may comprise an array of detecting surfaces aligned with the focal region of the lens.

In the example embodiments of the lens of FIGS. 1, 2 and/or 3, the transmissive portion 822, 522, of the rear surface 814, 514 of the lens 802, 502 comprises material such as glass or plastics material. In some examples, there may be a coating on the transmissive portion 822, 522 of the entrance surface, the transmissive portion 822, 522 of the exit surface 814 or the entrance plane 834 of the mounting portion 805. In some examples, there may be a filter between the lens 802 and the mounting portion 805 and/or between the mounting portion 805 and the detector 806 and/or at the window 831.

In the example embodiments of the lens of FIG. 3, the receiver 500 may comprise a Fresnel lens 502 and a detector 506 mounted directly on the exit surface 514 of the Fresnel lens 502. The receiver 500 does not have a mounting portion. The detector 506 is mounted to the transmissive portion 522 of the exit surface 514 of the Fresnel lens 502.

In some example embodiments, the mounting portion 805 has a central portion that may be hollow. The entrance plane 834 and exit plane 836 of the mounting portion may be or have an aperture or a hole. The central portion of the mounting portion 805 may have a cylindrical shape, where the entrance plane 834 and exit plane 836 have a circular cross section. In other examples, the central portion may have a cuboidal shape, where the entrance plane 834 and exit plane 836 have a rectangular cross section. The cross sectional area of the entrance plane 834 may be greater than the cross sectional area of the exit plane 836. In other examples, the cross sectional area of the entrance plane 834 and exit plane 836 may be the same. Further, in some examples, there may be an elongate waveguide region having the same shape as the entrance aperture of the mounting portion (e.g. cylindrical, or square) to increase the length of the mounting portion.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An optical transceiver comprising a transmitter and a receiver fixed relative to one another,
the transmitter comprising a light source and a directing element, wherein the directing element is configured to direct light emitted from the light source away from the optical transceiver along a light path, and wherein the directing element is configurable to adjust the light path, and
the receiver comprises a lens having a focal region at a focal length and a detector arranged at the focal region of the lens, wherein the receiver is configured with a function of merit (FOM):
$$FOM = {PSA}_{Aperture} \frac{A}{D}$$
wherein PSA_{Aperture} is the projected solid angle of the receiver, A is the area of the aperture of the receiver, D is the active area of the detector, and FOM is equal to at least 1.5.

2. The optical transceiver as claimed in claim 1, wherein the directing element is configurable to move the light path through an angle of at least 0.5 degrees.

3. The optical transceiver as claimed in claim 1, wherein the directing element is a mirror forming part of a microelectromechanical system.

4. The optical transceiver as claimed in claim 1, wherein the directing element is an optical phased array.

5. The optical transceiver as claimed in claim 1, wherein the optical receiver is operable at a bandwidth of at least 3 Mbit/s.

6. The optical transceiver according to claim 1, wherein the lens is a catadioptric lens

7. The optical transceiver as claimed in claim 1, comprising a housing, wherein the transmitter and receiver are fixed within the housing.

8-12. (canceled)

13. A free-space optical receiver comprising a catadioptric lens having a focal region at a focal length, and a detector arranged at the focal region, wherein the lens comprises a concave front surface and a flat rear surface, a flat reflector on the front surface and a flat reflector on the rear surface, wherein the flat reflector on the rear surface is arranged to reflect light that passes through the concave front surface to the flat reflector on the front surface, and the flat reflector on the front surface is arranged to reflect the light to the focal region of the lens.

14. A free-space optical receiver comprising a catadioptric lens having a focal region at a focal length and a detector arranged at the focal region, wherein the detector is embedded within the lens, between a light-receiving front surface and a reflecting rear surface of the lens, and wherein the lens is configured such that light entering the lens through the light-receiving front surface is reflected towards the focal region by the reflecting rear surface.

15. The optical receiver according to claim 14, wherein the detector is at least partly surrounded by a shell that comprises a material that is different from a material from which the lens is formed.

16. The optical receiver according to claim 14, wherein the detector is contained within a cavity formed in the lens, and is fixed within the cavity by an adhesive.

17. The optical transceiver according to claim 1, wherein the receiver is a free-space optical receiver comprising a lens having a focal region at a focal length, a mounting portion protruding away from a surface of the lens at the focal region, and a detector mounted to a distal end of the mounting portion, wherein the lens is configured to receive light from an acceptance angle of the lens and to direct said light to the detector via the mounting portion.

18. An arrangement comprising a first optical transceiver and a second optical transceiver, one or both of the first and second transceivers being a transceiver according to claim 1, wherein the transmitter of the first optical transceiver is configured to transmit an optical signal to the second optical transceiver, and wherein the detector of the receiver of the second optical transceiver is configured to receive the optical signal from the first optical transceiver.

19-21. (canceled)

22. The optical transceiver according to claim 1, wherein the receiver is a free-space optical receiver comprising a catadioptric lens having a focal region at a focal length, and a detector arranged at the focal region, wherein the lens comprises a concave front surface and a flat rear surface, a flat reflector on the front surface and a flat reflector on the rear surface, wherein the flat reflector on the rear surface is arranged to reflect light that passes through the concave front surface to the flat reflector on the front surface, and the flat reflector on the front surface is arranged to reflect the light to the focal region of the lens.

23. The optical transceiver according to claim 1, wherein the receiver is a free-space optical receiver comprising a catadioptric lens having a focal region at a focal length and a detector arranged at the focal region, wherein the detector is embedded within the lens, between a light-receiving front surface and a reflecting rear surface of the lens, and wherein the lens is configured such that light entering the lens through the light-receiving front surface is reflected towards the focal region by the reflecting rear surface.

24. The optical transceiver according to claim 23 wherein the detector is contained within a cavity formed in the lens, and is fixed within the cavity by an adhesive.
